(19) United States
(12) Patent Application Publication
(10) Pub. No.: US 2011/0292130 A1
(43) Pub. Date: Dec. 1, 2011

(54) LIQUID EJECTING HEAD

(75) Inventor: Hideki HAYASHI, Nagoya-shi (JP)

(73) Assignee: BROTHER KOGYO KABUSHIKI KAISHA, Nagoya-shi (JP)

(21) Appl. No.: 13/070,349

(22) Filed: Mar. 23, 2011

(30) Foreign Application Priority Data
May 26, 2010 (JP) 2010-120586

(51) Int. Cl. B41J 2/04

(52) U.S. Cl. 347/54

(57) ABSTRACT

A liquid ejecting head according to the present invention comprises a passage unit and an actuator unit. The passage unit includes: a plurality of liquid passages each of which contains a first opening for ejecting liquid and a pressure chamber connected to the first opening; and a surface having a plurality of second openings by which the pressure chambers are exposed. The actuator unit is fixed to the surface of the passage unit with a binder and covers the second openings. The actuator unit contains a plurality of actuators which face the second openings and apply ejection energy to the liquid inside the pressure chambers, respectively. The passage unit includes a plurality of plates which are stacked one another and have holes structuring the liquid passages. Of the plates, a first plate having the surface and at least another plate adjacent to the first plate have a dummy passage which is not in communication with the liquid passages. The dummy passage extends from one or more third openings formed within a fix area of the actuator unit on the surface of the first plate to one or more fourth openings formed on a surface of any of the plates, via a space formed in a plate other than the first plate. The dummy passage is opened to the atmosphere through the one or more fourth openings.

### CROSS REFERENCE TO RELATED APPLICATION

This application claims priority from Japanese Patent Application No. 2010-120586, which was filed on May 26, 2010, the disclosure of which is herein incorporated by reference in its entirety.

### BACKGROUND OF THE INVENTION

1. Field of the Invention

The present invention relates to a liquid ejecting head which ejects liquid such as ink or the like.

2. Description of Related Art

In an inkjet head which is an exemplary liquid ejecting head, a plurality of members forming the head are fixed to one another with a binder in some cases. When a binder is used, redundancy of the binder may move into ink passages of the head, thus deteriorating the ink ejection performance of the ejection openings. The ink ejection performance means the ejection speed, the ejection direction, the size of ink droplets ejected, or the like. For example, when the redundant binder moves into the ink passages corresponding to some of the ejection openings, the ink ejection performance becomes uneven among the ejection openings.

### SUMMARY OF THE INVENTION

A possible approach for reducing the above problem is to form a groove or the like on the member to which the redundant binder is released.

There are various forms of actuators which apply ejection energy to ink inside a pressure chamber, including one structured by a thin sheet functioning as a common electrode and an individual electrode disposed to face that thin sheet over a space. For example, there is an actuator unit which is fixed, with a binder, to the surface of the passage unit having ink passages including pressure chambers, the surface having thereon openings of the pressure chambers.

When an actuator unit is fixed to a surface of a passage unit with a binder, the redundant binder may move not only into the pressure chambers but also to the side and the surface of the actuator unit. This binds the actuator unit and may cause a problem in driving the actuator unit.

An object of the present invention is to provide a liquid ejecting head in which redundancy of a binder applied between an actuator unit and a passage unit is restrained from moving into the pressure chamber or to the side or the surface of the actuator unit.

An aspect of the present invention is a liquid ejecting head comprising a passage unit and an actuator unit. The passage unit includes: a plurality of liquid passages each of which contains a first opening for ejecting liquid and a pressure chamber connected to the first opening; and a surface having a plurality of second openings by which the pressure chambers are exposed. The actuator unit is fixed to the surface of the passage unit with a binder and covers the second openings. The actuator unit contains a plurality of actuators which face the second openings and apply ejection energy to the liquid inside the pressure chambers, respectively. The passage unit includes a plurality of plates which are stacked one another and have holes structuring the liquid passages. Of the plates, a first plate having the surface and at least another plate adjacent to the first plate have a dummy passage which is not in communication with the liquid passages. The dummy passage extends from one or more third openings formed within a fix area of the actuator unit on the surface of the first plate to one or more fourth openings formed on a surface of any of the plates, via a space formed in a plate other than the first plate. The dummy passage is opened to the atmosphere through the one or more fourth openings.

### BRIEF DESCRIPTION OF THE DRAWINGS

Other and further objects, features and advantages of the invention will appear more fully from the following description taken in connection with the accompanying drawings in which:

FIG. 1 is a schematic side view showing an interior structure of an inkjet printer having an inkjet head, according to one embodiment of the present invention.

FIG. 2 is a plan view showing a passage unit and an actuator unit of the inkjet head.

FIG. 3 is an enlarged view of an area III surrounded by a dotted line in FIG. 2.

FIG. 4A is a cross sectional view taken along the line IVA-IVA in FIG. 3.

FIG. 4B is a cross sectional view taken along the line IVB-IVB in FIG. 3.

FIG. 4C is a cross sectional view taken along the line IVC-IVC in FIG. 3.

FIG. 5 is a longitudinal cross sectional view of the inkjet head.

FIG. 6A is a partial enlarged cross sectional view of the actuator unit.

FIG. 6B is a plan view showing individual electrodes of the actuator unit.

FIG. 7 is an enlarged view showing an area VII surrounded by a double-dashed line in FIG. 3.

### DESCRIPTION OF THE PREFERRED EMBODIMENTS

The following describes a preferable embodiment of the present invention, with reference to the attached drawings.

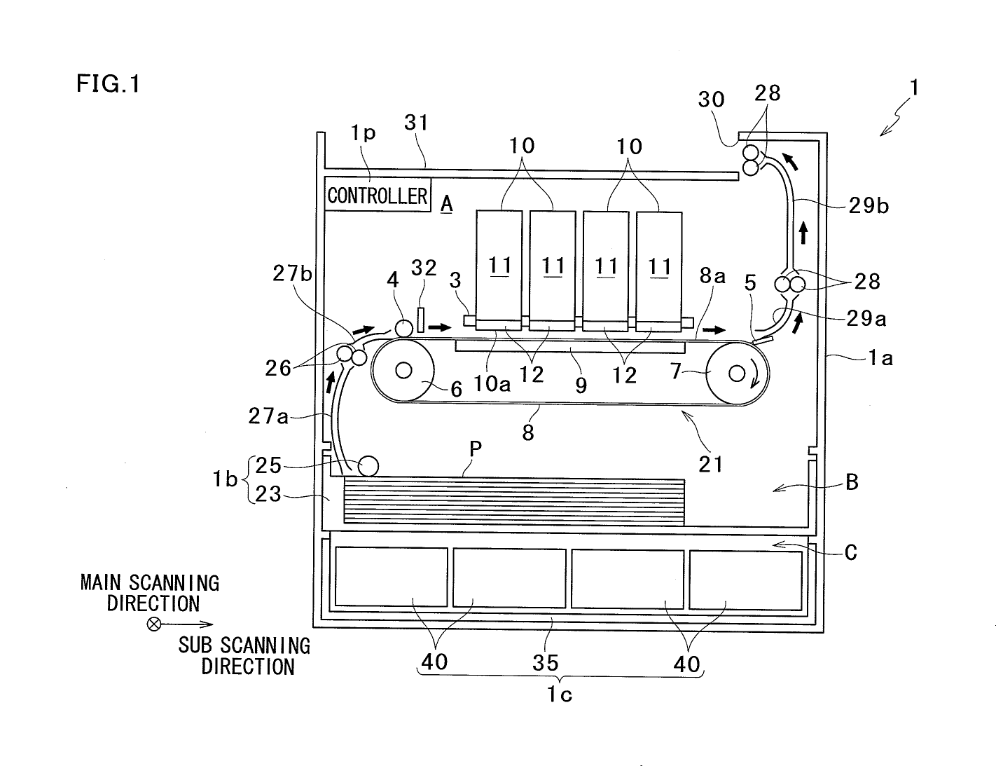

First, the following describes, with reference to FIG. 1, an overall structure of an inkjet printer 1 including an inkjet head 10 according to one embodiment of the present invention.

The printer 1 has a casing 1a having a rectangular parallelepiped shape. On top of the ceiling plate of the casing 1a is a sheet output unit 31. The space inside the casing 1a is divided into spaces A, B, and C in this order from the top. The spaces A and B are spaces having a sheet conveyance path connecting to a sheet output unit 31. In the space A, a paper sheet P is conveyed and is subjected to image formation. In the space B is performed an operation related to paper sheet feeding. The space C accommodates therein ink cartridges 40 each of which serves as an ink supply source.

In the space A are disposed four inkjet heads 10, a conveyance unit 21 which conveys a paper sheet P, a later-mentioned guide unit which guides the paper sheet P, and the like. In the upper part of the space A is disposed a controller 1p. The controller 1p controls operations of parts of the printer 1 having these structures, and thereby administrates the entire operation of the printer 1.

To form an image on a paper sheet P based on image data supplied from the outside, the controller 1p controls an operation related to preparation for image formation; operations of supplying, conveying, and outputting the paper sheet P; and an operation of ejecting ink in sync with the conveyance of the paper sheet P.

Each head 10 is longer in the main scanning direction (in a direction perpendicular to the paper sheet surface of FIG. 1). The outline of each head 10 is substantially in a rectangular parallelepiped shape. The four heads 10 are aligned at a predetermined pitch in a sub scanning direction, and are supported by the casing 1a through a head frame 3. In formation of an image, the four heads 10 eject from their under surfaces (ejection faces 10a) ink of Magenta, Cyan, Yellow, and Black, respectively. The specific structure of each head 10 is detailed later.

As shown in FIG. 1, the conveyance unit 21 has belt rollers 6 and 7, and an endless conveyor belt 8 looped around the both rollers 6 and 7. In addition to those, the conveyance unit 21 has a nip roller 4 and a separation plate 5 disposed outside loop formed by the conveyor belt 8, and a platen 9 disposed inside the loop formed by the conveyor belt 8.

The belt roller 7 is a drive roller whose rotation is driven by a not-shown conveyance motor, and rotates clockwise in FIG. 1. With the rotation of the belt roller 7, the conveyor belt 8 runs in a direction indicated by the bold arrow in FIG. 1. The belt roller 6 is a driven roller, which rotates clockwise in FIG. 1, with the movement of the conveyor belt 8. The nip roller 4 is disposed to face the belt roller 6, and presses a paper sheet P supplied from a later-mentioned upstream guide unit against an outer circumference 8a of the conveyor belt 8. The separation plate 5 is disposed to face the belt roller 7. The separation plate 5 separates the paper sheet P from the outer circumference 8a and leads the paper sheet P to a downstream guide unit. The platen 9 is disposed to face the four heads 10 over the conveyance belt 8, and supports the upper part of the loop of the conveyor belt 8 from inside the loop. This forms a predetermined space suitable for image formation between the ejection faces 10a of the heads 10 and the outer circumference 8a.

The guide unit includes the upstream guide unit and the downstream guide unit which are disposed to sandwich the conveyance unit 21. The upstream guide unit has two guides 27a and 27b and a pair of feed rollers 26. The guide unit connects a later-mentioned sheet-feeder unit 1b with the conveyance unit 21. The downstream guide unit has two guides 29a and 29b and two pairs of feed rollers 28. The guide unit connects the conveyance unit 21 and the sheet output unit 31.

In the space B is disposed a sheet-feeder unit 1b. The sheet-feeder unit 1b has a sheet-feeder tray 23 and a sheet-feeder roller 25. The sheet-feeder tray 23 is detachable from the casing 1a. The sheet-feeder tray 23 is a box with an opened top, and capable of storing paper sheets P of various sizes. The sheet-feeder roller 25 feeds out the uppermost one of the paper sheets P in the sheet-feeder tray 23, and supply that upper most paper sheet P to the upstream guide unit.

As mentioned above, the sheet conveyance path extending from the sheet-feeder unit 1b to the sheet output unit 31 via the conveyance unit 21 is formed in the spaces A and B. The paper sheet P, having been feeded out from the sheet-feeder tray 23 based on a record instruction, is supplied to the conveyance unit 21 via the upstream guide unit. When the paper sheet P passes immediately below the heads 10 in the sub scanning direction, the ejection faces 10a successively eject ink to form a color image on the paper sheet P. The paper sheet P is further conveyed through the downstream guide unit, and is output to the sheet output unit 31 from an opening 30 disposed above.

Note that the sub scanning direction is a direction parallel to the conveyance direction of the paper sheet P by the conveyance unit 21. The main scanning direction is a direction which is parallel to a horizontal plane, and perpendicular to the sub scanning direction.

In the space C is disposed an ink unit 1c. The ink unit 1c is detachable from the casing 1a. The ink unit 1c includes a cartridge tray 35, and four cartridges 40 which are accommodated and aligned in the tray 35. Each cartridge 40 supplies ink to the corresponding one of the heads 10 via a not-shown ink tube.

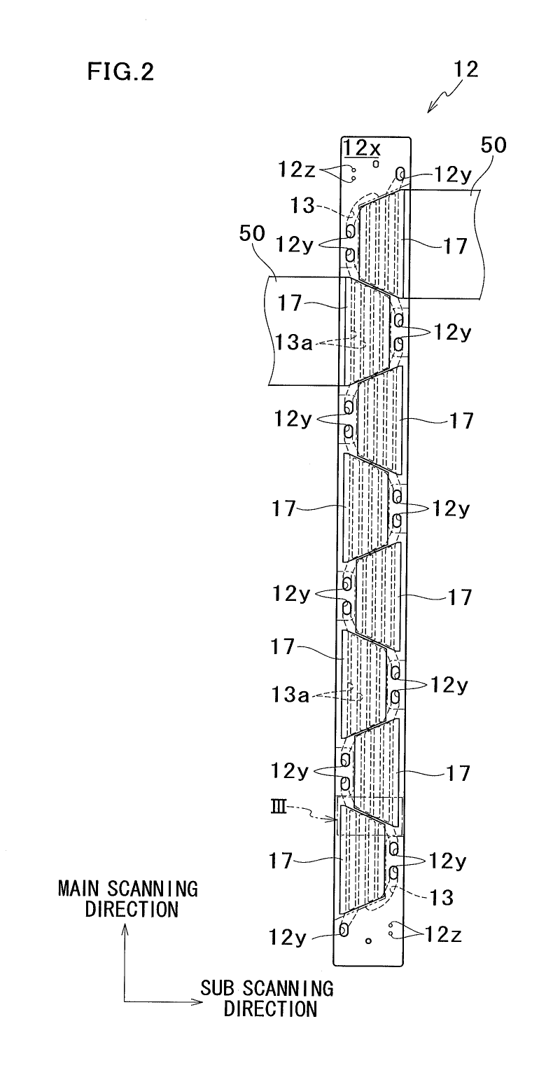

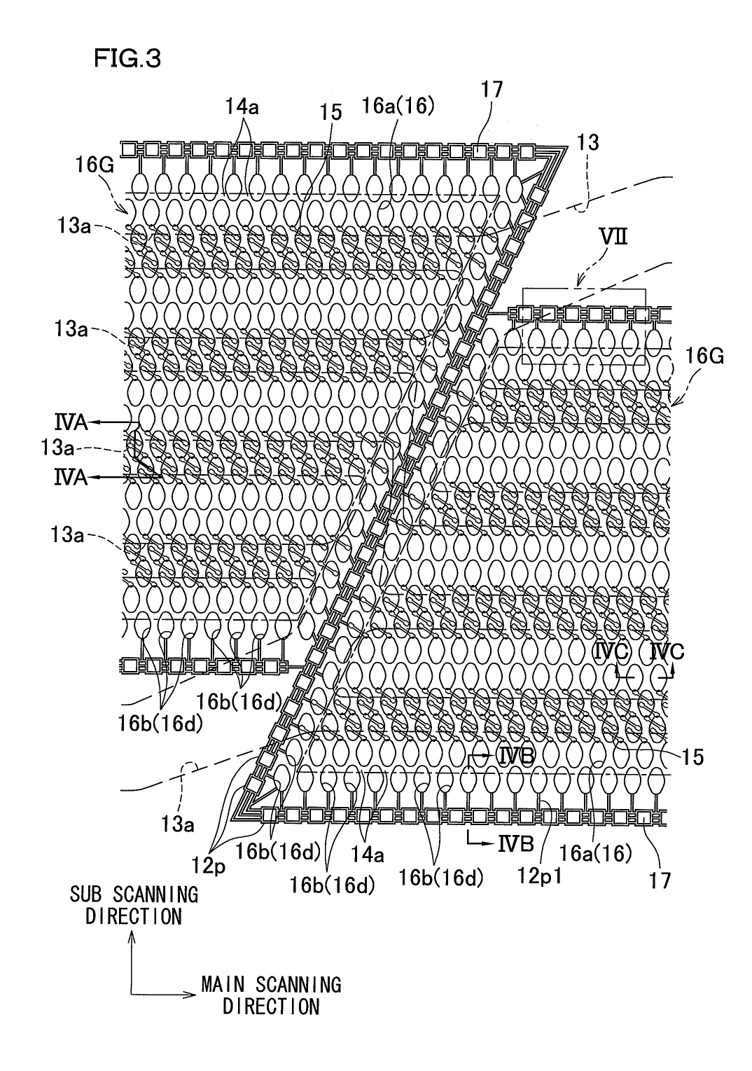

Next, the following details the head 10 with reference to FIG. 2 to FIG. 5. Note that FIG. 3 illustrates, in solid lines, apertures 15, pressure chambers 16, openings 16a, openings 16b of dummy pressure chambers 16d, and the like which are under actuator units 17, although these members should be illustrated in dotted lines.

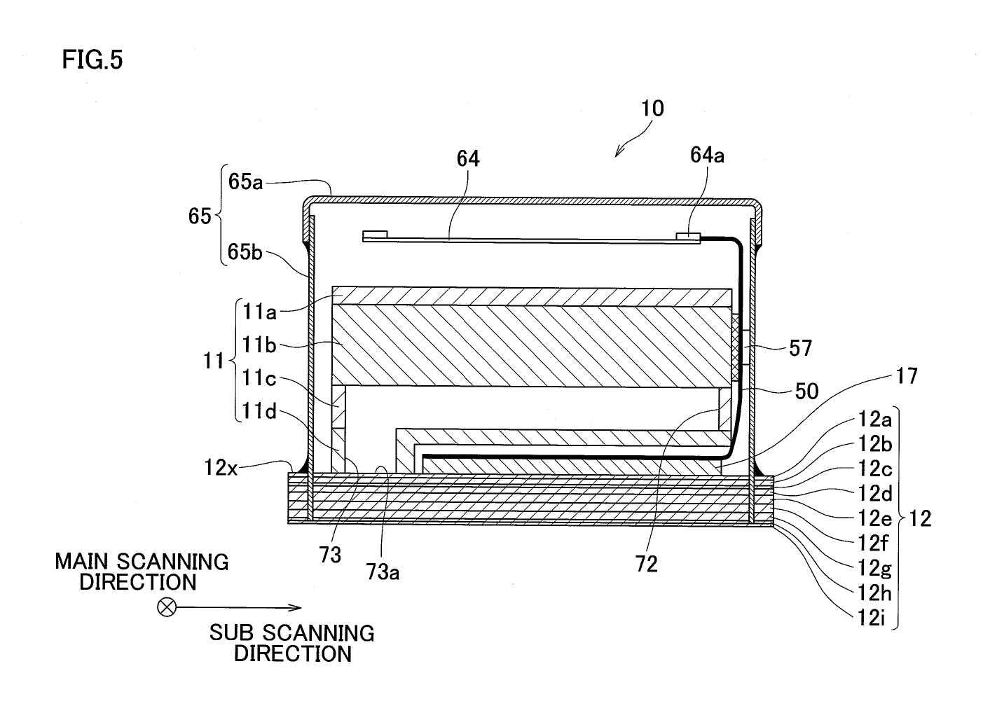

As shown in FIG. 5, each head 10 is a layered member in which a passage unit 12, the actuator units 17, a reservoir unit 11, and a substrate 64 are stacked. Of these layers, the actuator units 17, the reservoir unit 11, and the substrate 64 are accommodated in a space formed by the top surface 12x of the passage unit 12 and the cover 65. In this space, each of the actuator units 17 and the substrate 64 are electrically connected to each other via an FPC (Flexible Printed Circuit Board) 50. On the FPC 50 is mounted a driver IC 57.

As shown in FIG. 5, the cover 65 includes a top cover 65a and a side cover 65b. The cover 65 is a box with an opened bottom. This cover 65 is fixed to the top surface 12x of the passage unit 12. The side cover 65b is an aluminum plate, and also function as a heat sink. The driver IC 57 abuts the inner surface of the side cover 65b, and is thermally jointed to the cover 65b.

The reservoir unit 11 is a layered member in which four metal plates 11a to 11d each having a through hole or a recess are stacked one another. Inside the reservoir unit 11 is formed an ink passage including a reservoir 72. One end of the ink passage is connected to the cartridge 40 via a tube or the like, and the other end is opened to the under surface of the reservoir unit 11. On the plate 11d are formed ink outflow passages 73 each of which is a part of ink passage in the reservoir unit 11 and is in communication with the reservoir 72. Each of the passages 73 leads to an opening on the surface of the leading end of a protrusion on the under surface of the plate 11d; i.e., to the surface to be jointed to the top surface 12x.

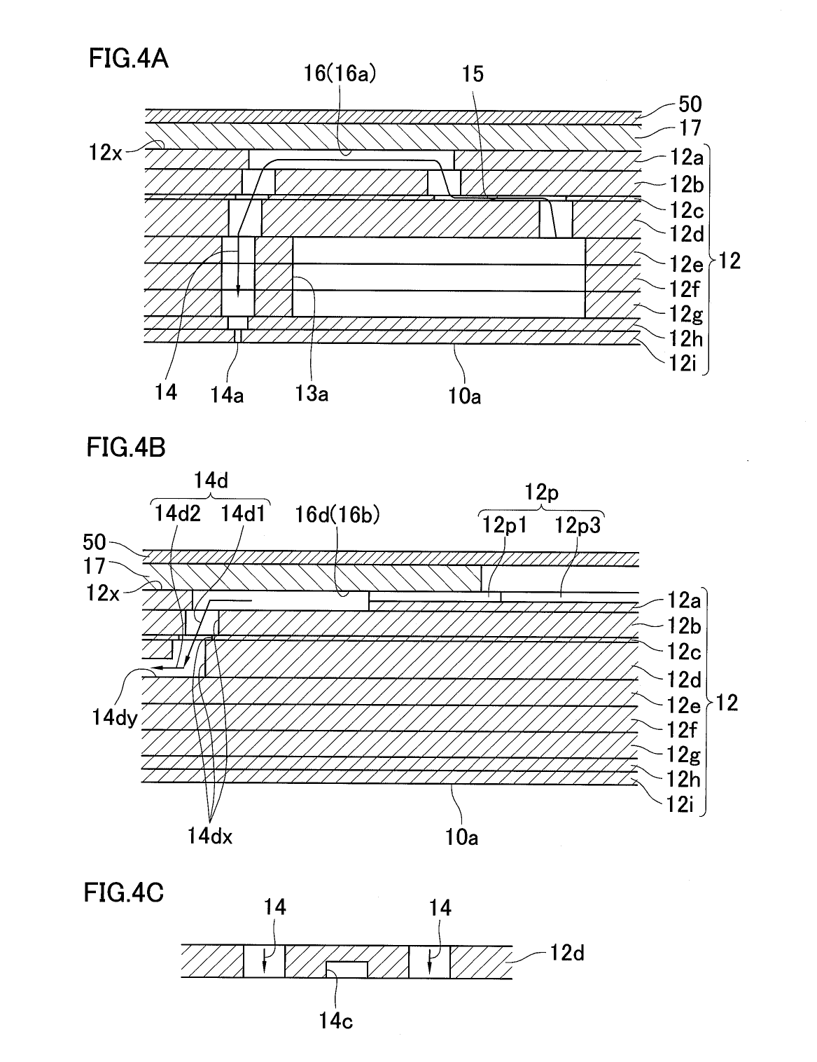

The passage unit 12 is a layered member in which nine rectangular metal plates 12a to 12i (see FIG. 4A) having substantially the same sizes are stacked one another. As shown in FIG. 2, on the top surface 12x of the passage unit 12 are formed openings 12y which face the openings 73a of the ink outflow passages 73, respectively. Inside the passage unit 12 are formed ink passages each extending from one of the openings 12y to ejection openings 14a; later-mentioned dummy passages 14d and later-mentioned inspection passages 14c which are not in communication with the ink passages. As shown in FIG. 2, FIG. 3, and FIG. 4A, each ink passage includes a manifold channel 13 having the opening 12y at one end, sub manifold channels 13a branched off from the manifold channel 13, and individual passages 14 extending from the outlet of the sub manifold channels 13a to the ejection openings 14a via pressure chambers 16.

As shown in FIG. 2 and FIG. 3, the manifold channel 13 and the sub manifold channels 13a are passages shared by a plurality of ejection openings 14a. The individual passages 14 on the other hand are provided for the ejection openings 14a, on one-to-one basis. As shown in FIG. 4A, each of the individual passages 14 includes an aperture 15 having a function of adjusting passage resistance, and a pressure chamber 16 which is opened to the top surface 12x. As shown in FIG. 3, the respective openings 16a of the pressure chambers 16 formed on the top surface 12x are substantially in the shape of a diamond, and are disposed in a matrix to structure eight opening groups 16G each occupying substantially a trapezoid area in plan view. These opening groups 16G are disposed in two lines in a zigzag manner, on the top surface 12x. Similarly, the ejection openings 14a formed on the ejection face 10a are disposed in a matrix as is the case of the openings 16a, thereby structuring a total of eight ejection opening groups each occupying substantially a trapezoid area in plan view.

Here, the ejection opening 14a serves as the first opening, and the opening 16a serves as the second opening.

As shown in FIG. 2, each actuator unit 17 has a trapezoid plane, and is disposed on the trapezoid area on the opening group 16G. The actuator unit 17 has its trapezoid base side close to a side of the passage unit 12 relative to the sub scanning direction. The actuator unit 17 is disposed within a gap created by the reservoir unit 11 and the passage unit 12 while avoiding the protrusion on the under surface of the reservoir unit.

The FPC 50 is provided to each of the actuator unit 17, and wiring corresponding to the electrodes of the actuator unit 17 is connected to the output terminal of the driver IC 57. Under control of the controller 1p (see FIG. 1), the FPC 50 communicates various drive signals adjusted in the substrate 64 (see FIG. 5) to the driver IC 57, and communicates various drive voltage generated by the driver IC 57 to the actuator unit 17.

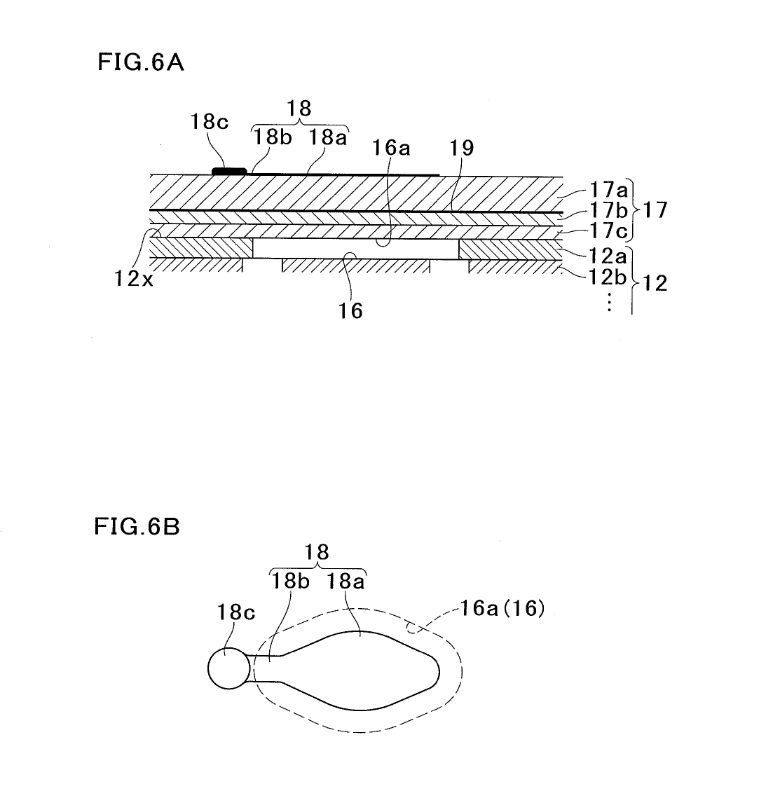

Next, the following describes the actuator unit 17, with reference to FIG. 6.

As shown in FIG. 6A, the actuator unit 17 has a layered member of two piezoelectric layers 17a and 17b, and an oscillation plate 17c disposed between the layered member and the passage unit 12. The piezoelectric layers 17a and 17b and the oscillation plate 17c are all sheet members made of a ceramic material based on a ferroelectric lead zirconate titanate (PZT). The piezoelectric layer 17a is polarized in thickness directions thereof.

The piezoelectric layers 17a and 17b and the oscillation plate 17c are all the same in size and shape (a trapezoid shape defining the shape of each actuator unit 17). That is, the piezoelectric layers 17a and 17b and the oscillation plate 17c are extended over the openings 16a in one of the opening groups 16G, and cover the entire trapezoid area of that opening group 16G. All of the openings 16a in the opening group 16G are therefore closed by the oscillation plate 17c.

On the top surface of the piezoelectric layer 17a is formed a number of individual electrodes 18 corresponding to the pressure chambers 16 respectively. Between the piezoelectric layer 17a and the piezoelectric layer 17b therebelow is a common electrode 19. No electrode is formed on the oscillation plate 17c.

As shown in FIG. 6B, each individual electrode 18 includes a main electrode area 18a substantially in the shape of diamond, an extended portion 18b extended from one of sharp angle portions of the main electrode area 18a, and a land 18c formed on the extended portion 18b. The main electrode area 18a has a shape which resembles to that of the opening 16a, and is disposed within the opening 16a in plan view. The extended portion 18b is extended to the outside area of the opening 16a, and the land 18c is disposed on the leading end. The land 18c has a circular outline in plan view, and does not face the opening 16a. Further, the land 18c has a height of approximately 50 μm from the top surface of the piezoelectric layer 17a, and is electrically connected to a terminal of the wiring of the FPC 50.

The common electrode 19 is formed throughout the entire piezoelectric layer 17b. The common electrode 19 is electrically connected to a not-shown land for the common electrode formed on the top surface of the piezoelectric layer 17a. The land for the common electrode is disposed nearby each corner of the trapezoid on the top surface of the piezoelectric layer 17a, and is connected to the terminal of the FPC 50. The potential of this land is always kept at the ground level (0V).

The portion of the piezoelectric layer 17a sandwiched between the electrodes 18 and 19 serves as an active portion which, upon application of an electric field in thickness directions, contracts in in-plane directions due to a transversal piezoelectric effect. When the potential of the individual electrode 18 is made different from that of the common electrode 19, the active portion contracts in in-plane directions due to a transversal piezoelectric effect. Since the other layers (layers 17b and 17c other than the piezoelectric layer 17a) are not spontaneously displaced, there will be a difference in the level of deformation between these layers and the active portion. Due to the difference, in the actuator unit 17, the portion facing the opening 16a is deformed in a convex shape towards inside the pressure chamber 16 (unimorph deformation), thus applying ejection energy to the ink inside the pressure chamber 16. The portion facing the opening 16a of the actuator unit 17 is a piezoelectric actuator, which is provided for each of the pressure chambers 16, and is deformed independently of those of the other pressure chambers 16.

Next, the following describes the dummy passages 14d.

As shown in FIG. 4B, each of the dummy passages 14d is formed on the top four plates 12a to 12d among the plates 12a to 12i forming the passage unit 12. The plates 12a, 12b, 12c, and 12d are, for example, 80 μm, 100 μm, 20 μm, and 150 μm in thickness, respectively. That is, the plate 12d is the thickest among the plates 12a to 12d.

Each dummy passage 14d extends from a dummy pressure chamber 16d formed on the cavity plate 12a at the uppermost layer to one of openings 12z (see FIG. 2) formed on the top surface 12x, via a through hole 14dx penetrating the plates 12b to 12d, and a recess 14dy formed on the under surface of the supply plate 12d. As shown in FIG. 2, there are four openings 12z on the top surface 12x of the passage unit 12; two of which are formed on one end and another two formed on the other end of the top surface 12x relative to the main scanning direction. All of the opening groups 16G are sandwiched between the openings 12z relative to the main scanning direction.

The dummy pressure chamber 16d is structured by a through hole penetrating the plate 12a in the thickness directions. As shown in FIG. 3, the plate 12a has the openings 16b of the dummy pressure chambers 16d, within a fix area of each actuator unit 17 on the surface of the plate 12a (top surface 12x). These openings 16b surround the opening group 16G along a periphery of the fix area (along the four sides of the trapezoid). The openings 16b each has the same size and shape as those of the opening 16a, and are positioned in the same pattern as the openings 16a.

Here, the opening 16b serves as the third opening, and the opening 12z serves as the fourth opening.

The dummy passage 14d is formed for each dummy pressure chamber 16d. The dummy passage 14d is structured by partial passages 14d1 and 14d2, and a not-shown partial passage connecting the leading end of the partial passage 14d2 and the opening 12z. The partial passage 14d1 is structure by three through holes 14dx. The partial passage 14d2 is mainly the recess 14dy, and has one end connected to the through hole 14dx of the plate 12d and another end nearby the corresponding one of the openings 12z. The other end of the recess 14dy is connected to one of the openings 12z via a not-shown through hole (a through hole formed through the plates 12a to 12d) or the like.

Next, a groove 12p is described.

The groove 12p is structured by a recess formed on the surface (top surface 12x) of the plate 12a. The groove 12p is provided further outward than the dummy pressure chambers 16d. The groove 12p in plan view has a shape such that a plurality of grids are connected to one another via long lines. The groove 12p surrounds the actuator unit 17 along the periphery of the fix area (along four sides of the trapezoid), and covers the boundary of the fix area of the actuator unit 17.

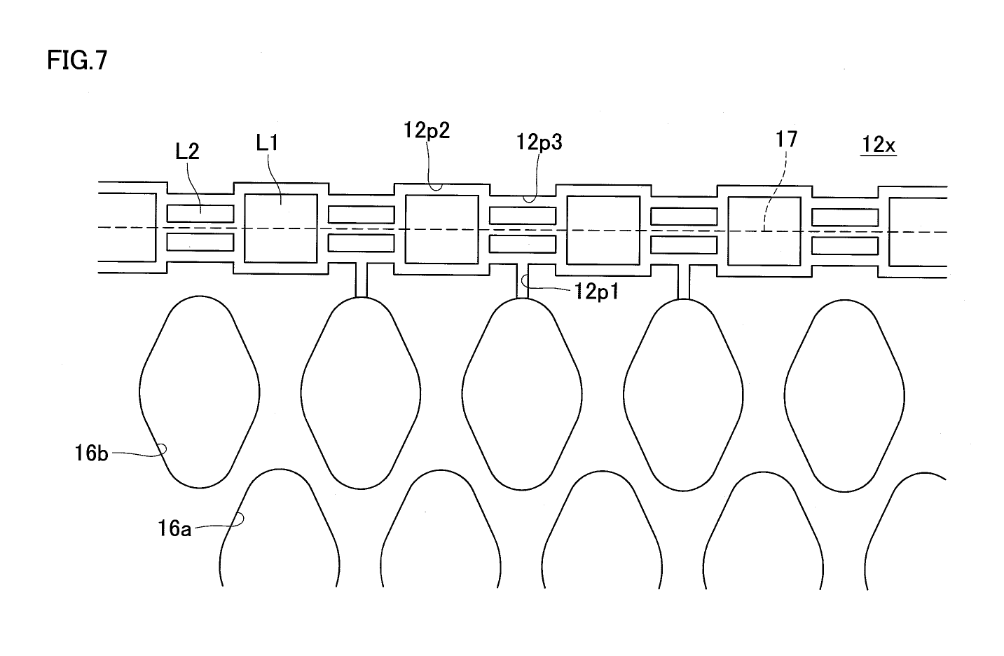

As shown in FIG. 7, the groove 12p has connect portions 12p1 and 12p3 and grid portions 12p2. Each of the connect portions 12p1 is a linear groove, whose one end is connected to the opening 16b. The grid portion 12p2 is a groove forming a quadrangular outline, and defines a quadrangular island L1. A number of islands L1 are aligned along the sides of the actuator unit 17 at regular intervals. The border line of the actuator unit 17 (broken line in FIG. 7) is in the middle of the islands L1. Each of the connect portions 12p3 is a linear groove and connects the grid portions 12p2 one another. There are three connect portions 12p3 which connect adjacent grid portions 12p2, and these three connect portions 12p3 and the grid portions 12p2 defines rectangular islands L2. The border line of the actuator unit 17 is in the middle of one of the connect portions 12p3 between the two islands L2. As shown in FIG. 7, the connect portions 12p3 and the grid portions 12p2 are partially outside the actuator unit 17 in plan view, and are in communication with the atmosphere. Thus, the openings 16b are in communication with the atmosphere through the groove 12P.

The islands L1 and L2 adjust the amount of binder moving inside the border line of the actuator unit 17, while supporting the actuator unit 17 from the bottom to prevent damages to the side of the actuator unit 17.

Next, the inspection passages 14c are described. Each of the inspection passages 14c is used for inspecting a leakage from the individual passages 14.

As shown in FIG. 4C, the inspection passage 14c is structured by a recess formed on the under surface of the plate 12d, and is disposed between adjacent individual passages 14. The inspection passage 14c extends along the under surface of the plate 12d. The inspection passage 14c is not in communication with the individual passages 14. The inspection passage 14c however is connected to the recess 14dy at a not-illustrated position and therefore is in communication with the dummy passage 14d.

As described above, with the head 10 of the present embodiment, redundancy of the binder applied between the actuator unit 17 and the passage unit 12 is received by the openings 16b each of which is one end of a dummy passage 14d. The dummy passage 14d has another end which is opened to the atmosphere through the opening 12z. Therefore, the redundant binder more likely moves into the openings 16b. Thus, it is possible to restrain the redundant binder from moving into the pressure chambers 16 or to the side or the surface (the surface opposite to the surface facing the passage unit 12) of the actuator unit 17.

Further, the structure of the present embodiment allows inspection of leakage between the individual passage 14 and the dummy passage 14d. Specifically, for example, the entire ejection face 10a (all of the ejection openings 14a formed on the ejection face 10a) is covered by a not-shown cap. Then, the inside of the cap is depressurized. Then, the pressure inside the cap is measured. If the plates 12a to 12d are well fixed to one another, the individual passages 14 and the dummy passages 14d are not in communication. Therefore, the pressure inside the cap remains depressurized. However, if the individual passages 14 and the dummy passages 14d are partially in communication due to defective fixing caused by the presence of a space or foreign materials between the plates 12a to 12d, the pressure inside the cap becomes the atmospheric pressure after the depressurization, because the dummy passages 14d are opened to the atmosphere. Inspecting such a leakage improves the quality of the head 10.

As shown in FIG. 3, the openings 16b are positioned along the periphery of the fix area of each actuator unit 17, outside the opening group 16G constituted by the openings 16a formed within the fix area. This more effectively restrains the redundant binder from moving to the side or the surface of the actuator unit 17.

As shown in FIG. 3, the openings 16b surround the opening group 16G along the periphery of the fix area of the actuator unit 17. This restrains movement of the redundant binder to the side or the surface of the actuator unit 17, throughout the entire periphery of the actuator unit 17. Further, it is possible to restrain the difference in the amount of redundant binder moving into the pressure chamber 16 between the openings 16a nearby the periphery of the fix area and the openings 16a inside the fix area. This uniformalizes the respective deformabilities of the piezoelectric actuators in the actuator unit 17, thus improving the recording quality.

As shown in FIG. 3, the openings 16b have the same size and shape as those of the opening 16a. Further, the openings 16b are positioned in the same pattern as the openings 16a. That is, any one of the openings 16b and the other openings 16a and 16b around that one opening 16b have the same positional relation as the positional relation among the openings 16a in the opening group 16G. The above structure enables easier manufacturing of the passage unit 12, and reliably brings about the above-mentioned effect: i.e., to restrain movement of the redundant binder to the side or the surface of the actuator unit 17 throughout the entire periphery of the actuator unit 17; and to restrain the difference in the amount of redundant binder moving into the pressure chamber 16 between the openings 16a nearby the periphery of the fix area and the openings 16a inside the fix area. Further, the above arrangement of the openings 16b uniformalizes the hardness of the area around each pressure chamber 16 of the opening group 16G on the passage unit 12, thus equalizing the ink ejection characteristics of the ejection openings 14a included in the group 16G.

The passage unit 12 includes the inspection passage 14c (see FIG. 4C). The inspection passage 14c is positioned between the individual passages 14, and is not in communication with the individual passages 14 while being in communication with the dummy passage 14d. With the provision of the inspection passage 14c, it is possible to inspect not only the leakage between the individual passage 14 and the dummy passage 14d, but also the leakage between the individual passages 14. In other words, when the leakage between the individual passage 14 and the dummy passage 14d is inspected, the leakage between the individual passages 14 is inspected at the same time. Since a single inspection process of leakage enables both of inspection of the leakage between the individual passage 14 and the dummy passage 14d, and inspection of the leakage between the individual passages 14, the number of processes is reduced. Thus, the head 10 with an improved quality is realized at the low costs.

The openings 12z sandwich the individual passages 14 formed in the passage unit 12 in plan view, as shown in FIG. 2. For example, when a leakage is detected in the inspection, the part where the leakage has occurred is confirmed by, for example, supplying a colored ink from the opening 12z on one side to the opening 12z on the other side; e.g., from the two openings 12z at the upper part of the FIG. 2 to the two openings 12z at the lower part of the FIG. 2.

As shown in FIG. 4B, the dummy passage 14d includes: the partial passage 14d1 extending from the opening 16b through the through hole 14dx penetrating the plates 12a to 12d; and the partial passage 14d2 including the recess 14dy, which extends along the under surface of the plate 12d. The partial passage 14d2 is formed on the surface of the plate 12d which is the thickest plate among the plates 12a to 12d forming the partial passage 14d1. Therefore, formation of the partial passage 14d2 is easy, and a relatively large volume is easily ensured for the partial passage 14d2. Further, thanks to the large volume, even when the plate 12d is stacked to the other plates 12c and 12e with a binder, the partial passage 14d2 is hardly clogged by the binder.

When a layered member having a plurality of plates is manufactured, a binder is usually applied to the respective under surfaces of the plates except for the lowermost plate, and the plates are fixed to one another while positioning each plate. In the present embodiment, the recess 14dy is formed on the under surface of the plate 12c1, and not on the top surface thereof. This facilitates redundancy of the binder applied on the under surface (the binder for fixing the plate 12d to the plate 12e) to easily move into the partial passages 14d2. Further, to form the partial passage 14d2 (recess 14dy) by etching, formation of a recess with a large volume is easier on the under surface than the top surface of a plate, due to the structure of the etching process or apparatus. In this case too, the present embodiment is advantageous, because formation of a partial passage 14d2 with a relatively large volume is possible on the under surface of the plate 12d.

Further, with the groove 12p, the redundant binder at the periphery of the actuator unit 17 is released. Therefore, movement of the redundant binder to the side or the surface of the actuator unit 17 is effectively restrained.

The structure (shape, size, arrangement, and the like) of the groove 12p is not particularly limited, and may be modified to any structure. Further, it is possible to omit the groove 12p.

The inspection passage 14c may be formed in any shape on any plate structuring the passage unit 12. Further, it is possible to omit the inspection passage 14c.

The partial passage 14d2 (recess 14dy) may be formed on the top surface of the plate 12d or on the surface of a plate other than the plate 12d which is the thickest among the plates 12a to 12d in which the partial passage 14d1 is formed.

The dummy passage 14d may be formed on any one of the plates structuring the passage unit 12, including the two plates at the top (e.g. on the top two or three plates, or on all of the plates, or the like). Further, the space created by the dummy passage 14d is not particularly limited, provided that the space extends from the third opening(s) to the fourth opening(s) via a space formed in any of the plates structuring the passage unit 12 other than the first plate having the third opening(s). In the present embodiment, the above space is structured by the recess 14dy formed on the under surface of the plate 12d. However, the space may be formed on the surface of or inside any of the plates 12b to 12i; i.e., on any of the plates except the plate 12a.

The position of the fourth opening is on a plate structuring the passage unit, and is not particularly limited as long as the fourth opening is in communication with the atmosphere. For example, instead of forming the fourth opening on the surface (top surface 12x) of the plate 12a at the uppermost layer, the fourth opening may be formed on a side face of any of the plates 12a to 12i, or on the under surface (ejection face 10a) of the plate 12i at the lowermost layer. In such a case however, it is preferable to provide a recess or the like at a portion of the dummy passage nearby the fourth opening, for the purpose of preventing leakage of the binder from the fourth opening.

The above embodiment deals with a case where a plurality of fourth openings (the openings 12z) sandwich, in plan view, all of the individual passages 14 formed in the passage unit 12. The positions of the fourth openings however is not limited to such positions. For example, the fourth openings may be formed only one side of the passage unit 12 relative to the main scanning direction. Further, it is not necessary to provide a plurality of fourth openings, i.e., a single fourth opening is possible. Alternatively, the fourth opening may be formed for each of the actuator unit 17. In such a case, the fourth opening is preferably formed in a position nearby the upper base of the actuator unit 17.

The third opening may be modified to any shape, size, or arrangement. For example, the shape and size of the third opening may be different from those of the second opening. Further, the position of the third opening is not particularly limited as long as the third opening is on the surface of the first plate, within the fix area of the actuator unit. For example, the third opening may be positioned along one side of the trapezoid shape of the opening group 160, instead of forming the third opening to surround the opening group 16G.

The holes structuring the liquid passages, which are provided to the plates 12a to 12i of the passage unit 12, may be in the form of recesses and are not limited to through holes.

Each actuator of the actuator unit is not limited to a piezoelectric actuator, and may be, for example, a heat generating element used in a thermal method, or an element used in an electrostatic method.

The application of the liquid ejecting head of the present invention is not limited to a printer. The liquid ejection head of the present invention is applicable to facsimile machines, photocopiers, and the like. Further, the liquid ejecting head of the present invention may eject a liquid other than ink.

The recording medium is not limited to the paper sheet P, as long as recording is possible. For example, the recording medium may be a piece of fabric or the like.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A liquid ejecting head comprising a passage unit and an actuator unit; wherein:
the passage unit includes: a plurality of liquid passages each of which contains a first opening for ejecting liquid and a pressure chamber connected to the first opening; and a surface having a plurality of second openings by which the pressure chambers are exposed;
the actuator unit is fixed to the surface of the passage unit with a binder and covers the second openings, the actuator unit containing a plurality of actuators which face the second openings and apply ejection energy to the liquid inside the pressure chambers, respectively;
the passage unit includes a plurality of plates which are stacked one another and have holes structuring the liquid passages;
of the plates, a first plate having the surface and at least another plate adjacent to the first plate have a dummy passage which is not in communication with the liquid passages; and
the dummy passage extends from one or more third openings formed within a fix area of the actuator unit on the surface of the first plate to one or more fourth openings formed on a surface of any of the plates, via a space formed in a plate other than the first plate, the dummy passage being opened to the atmosphere through the one or more fourth openings.

2. The liquid ejecting head according to claim 1, wherein the third openings are positioned along a periphery of the fix area, outside an opening group constituted by the second openings formed within the fix area.

3. The liquid ejecting head according to claim 2, wherein the third openings surround the opening group along the periphery of the fix area.

4. The liquid ejecting head according to claim 3, wherein the third openings have the same size and shape as those of the second openings, and the positional relation among any one of the third openings, the second openings, and the other third openings is the same as the positional relation among the second openings in the opening group.

5. The liquid ejecting head according to claim 1, wherein the fourth opening is formed on the surface of the first plate.

6. The liquid ejecting head according to claim 1, wherein the passage unit includes an inspection passage between the liquid passages, the inspection passage being in communication with the dummy passage but not in communication with the liquid passages.

7. The liquid ejecting head according to claim 1, wherein the third openings sandwich the liquid passages, when viewed from a direction perpendicular to the surface.

8. The liquid ejecting head according to claim 1, wherein the dummy passage includes: a first portion extending from the third opening through the first plate and at least one of the plates adjacent to the first plate, in a direction crossing the surface; and a second portion formed on a surface of a second plate which is the thickest plate among the plates in which the first portion is formed, the second portion extending along the surface of the second plate from an end of the first portion opposite to an end connecting to the third opening.

9. The liquid ejecting head according to claim 8, wherein the surface of the second plate is opposite to the first plate.

10. The liquid ejecting head according to claim 1, wherein:
a to-atmosphere ventilation groove is formed outside and along the periphery of the fix area, on the surface of the first plate; and
the third openings are connected to the to-atmosphere ventilation groove.
